(19) United States
(12) Patent Application Publication
(10) Pub. No.: US 2014/0097582 A1
(43) Pub. Date: Apr. 10, 2014

(54) TOOL ADAPTER

(71) Applicant: Tzu-Chien Wang, Tainan City (TW)

(72) Inventor: Tzu-Chien Wang, Tainan City (TW)

(21) Appl. No.: 13/645,433

(22) Filed: Oct. 4, 2012

(51) Int. Cl. B23B 51/12

(52) U.S. Cl. 279/145

(57) ABSTRACT

A tool adapter includes a first sleeve received in a movable sleeve. The movable sleeve is movable in an axial direction to control movement of a first ball in a first through-hole in the first sleeve for controlling engagement with or detachment from a screwdriver shank of an automatic tool. A coupling rod is coaxial to the first sleeve and includes a rear section engaged with the first sleeve. A second sleeve includes a front end for coupling with a tool, such as a socket. The second sleeve includes an engagement groove receiving the coupling rod. The second sleeve is movable in the axial direction to control movement of a second ball in a second through-hole in the second sleeve for controlling engagement with or detachment from the tool.

### BACKGROUND OF THE INVENTION

The present invention relates to a tool adapter and, more particularly, to a tool adapter that can be easily assembled and detached for use with an automatic tool.

Conventional automatic electric or pneumatic tools include a coupler to which a driving member is attached. The driving member is generally in the form of a screwdriver shank that is driven to rotate when the coupler rotates. An adapter is used if a socket or another tool is needed in operation, with the screwdriver shank coupled to an end of the adapter, with the socket coupled to the other end of the adapter. Thus, the screwdriver shank, the adapter, and the socket rotate jointly when the automatic tool operates. However, disengagement of the adapter is apt to occur during high-speed operation of the automatic tools. If the engagement of the ends of the adapter with the screwdriver shank and the socket is enhanced to avoid the disengagement, the tight engagement will result in inconvenience to assembly.

### BRIEF SUMMARY OF THE INVENTION

An objective of the present invention is to provide a tool adapter that can be easily assembled and detached for use with an automatic tool.

A tool adapter according to the present invention includes a driving member coupling mechanism and a tool coupling mechanism. The driving member coupling mechanism includes a first sleeve, a movable sleeve, and a first elastic element. The first sleeve includes front and rear ends spaced in an axial direction, with the rear end of the first sleeve including an insertion hole, with the insertion hole adapted to couple with a screwdriver shank of an automatic tool. The first sleeve further includes a first through-hole extending in a radial direction perpendicular to the axial direction and in communication with the insertion hole. A first ball is received in the first through-hole. The movable sleeve includes a sleeve hole receiving the first sleeve. The movable sleeve is movable in the axial direction relative to the first sleeve, causing the first ball to move between a first location partially protruding out of the insertion hole and a second location not protruding out of the insertion hole. The first elastic element biases the movable sleeve to a first position in which the first ball protrudes out of the insertion hole. The movable sleeve is movable to a second position in which the first ball does not protrude out of the insertion hole.

The tool coupling mechanism includes a coupling rod, a second sleeve, and a second elastic element. The coupling rod is coaxial to the first sleeve and includes rear and front sections. The rear section of the coupling rod is securely engaged with the front end of the first sleeve. The front section of the coupling rod includes a front end having a first abutment section and a second abutment section. The second sleeve includes a front end having an engagement portion, with the engagement portion of the second sleeve adapted to couple with a tool. The second sleeve further includes an engagement groove extending in the axial direction. The engagement groove receives the coupling rod. The engagement groove includes rear and front groove sections in rear and front ends thereof and having sizes corresponding to the rear and front sections of the coupling rod. The second sleeve further includes a second through-hole extending in a radial direction perpendicular to the axial direction and in communication with the front groove section, with the second through-hole located corresponding to the first and second abutment sections of the coupling rod. A second ball is received in the second through-hole. The second elastic element provides a returning function for the second sleeve relative to the coupling rod. The second elastic element biases the coupling rod such that the second ball partially protrudes out of the second through-hole. The second sleeve is movable in the axial direction to a position in which the second ball does not protrude out of the second through-hole.

Preferably, the driving member coupling mechanism further includes first and second stop rings. The front end of the first sleeve includes a coupling section having a coupling hole. The first sleeve includes an annular groove in an outer periphery thereof. The first stop ring is received in the annular groove. A first inner annular wall portion is provided on a rear end of an inner periphery of the movable sleeve and protrudes into the insertion hole. The first inner annular wall portion has a diameter smaller than an outer diameter of the first stop ring. A second inner annular wall portion is provided on a front end of the inner periphery of the movable sleeve and has a diameter larger than the diameter of the first inner annular wall portion. The second inner annular wall portion receives an edge of the first ball such that the first ball does not protrude beyond the insertion hole. The second stop ring is located in a front end of the second inner annular wall portion. The first elastic element is a compression spring mounted around the first sleeve, with two ends of the first elastic element abutting against the first and second stop rings, providing the movable sleeve with operative resilience.

Preferably, the rear section of the coupling rod is securely engaged with the coupling hole of the coupling section of the first sleeve. The front section of the coupling rod has a diameter smaller than a diameter of the rear section of the coupling rod. A first shoulder is formed between the front and rear sections of the coupling rod. The first abutment section is shallower than the second abutment section. The second elastic element is a compression spring mounted in the rear groove section of the second sleeve. The second sleeve includes a second shoulder between the rear and front groove sections, with two ends of the second elastic element abutting against the first and second shoulders, providing the second sleeve with operative resilience.

The present invention will become clearer in light of the following detailed description of illustrative embodiments of this invention described in connection with the drawings.

### DESCRIPTION OF THE DRAWINGS

FIG. 1 shows an exploded, perspective view of a tool adapter according to the present invention.

FIG. 2 shows a perspective view of the tool adapter of FIG. 1.

FIG. 3 shows a cross sectional view according to section line A-A of FIG. 2.

FIG. 4 shows a cross sectional view of the tool adapter, a screwdriver shank, and a socket.

FIG. 5 shows a view similar to FIG. 4, with a second sleeve of a tool coupling mechanism moved.

FIG. 6 shows a view similar to FIG. 5, with a movable sleeve of a driving member coupling mechanism moved.

FIG. 7 shows a view illustrating removal of the tool adapter from an automatic tool.

### DETAILED DESCRIPTION OF THE INVENTION

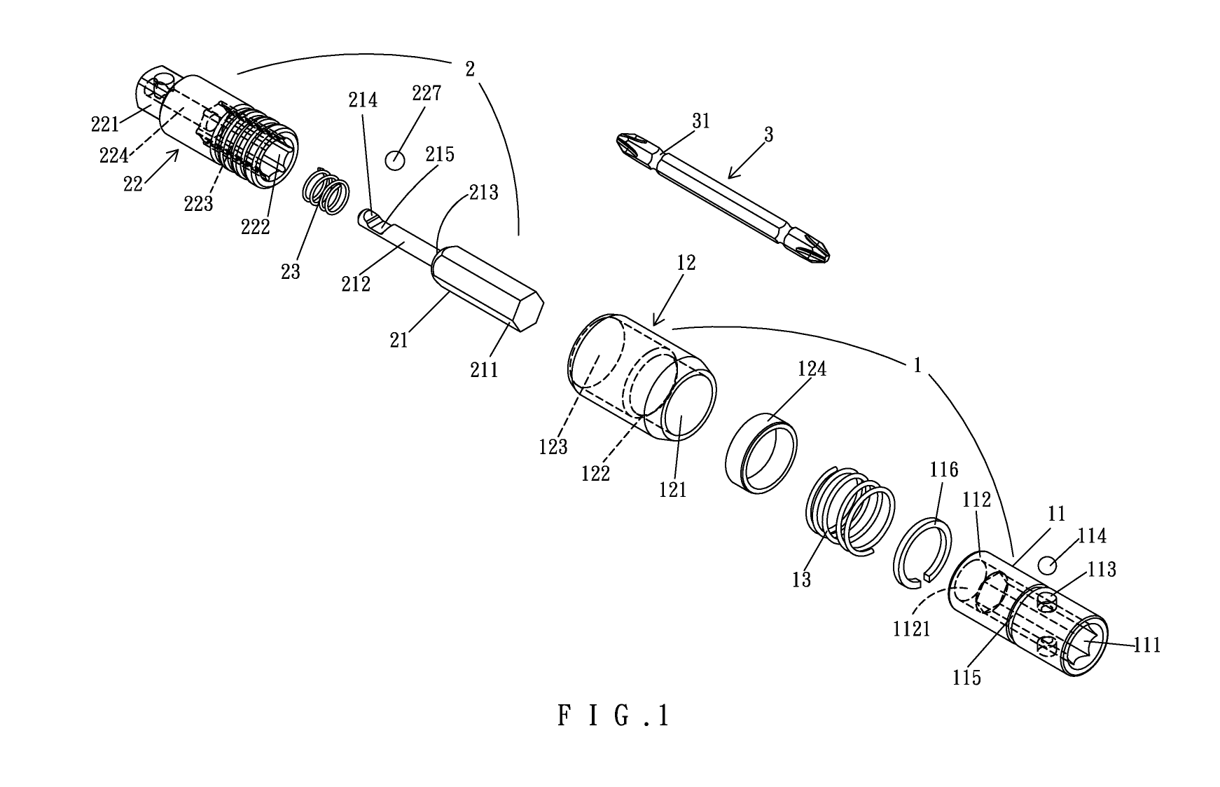

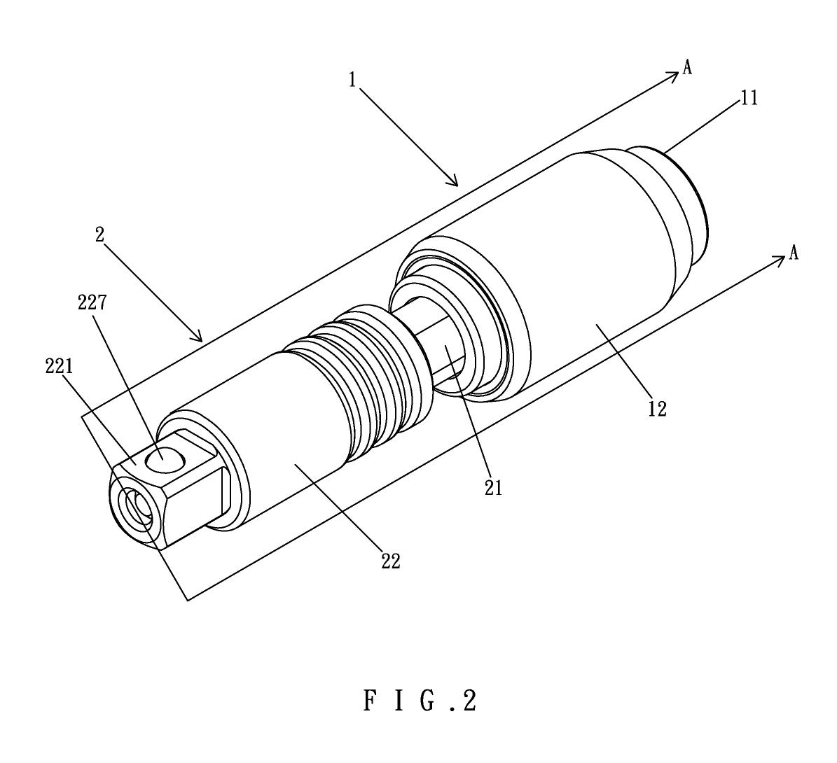

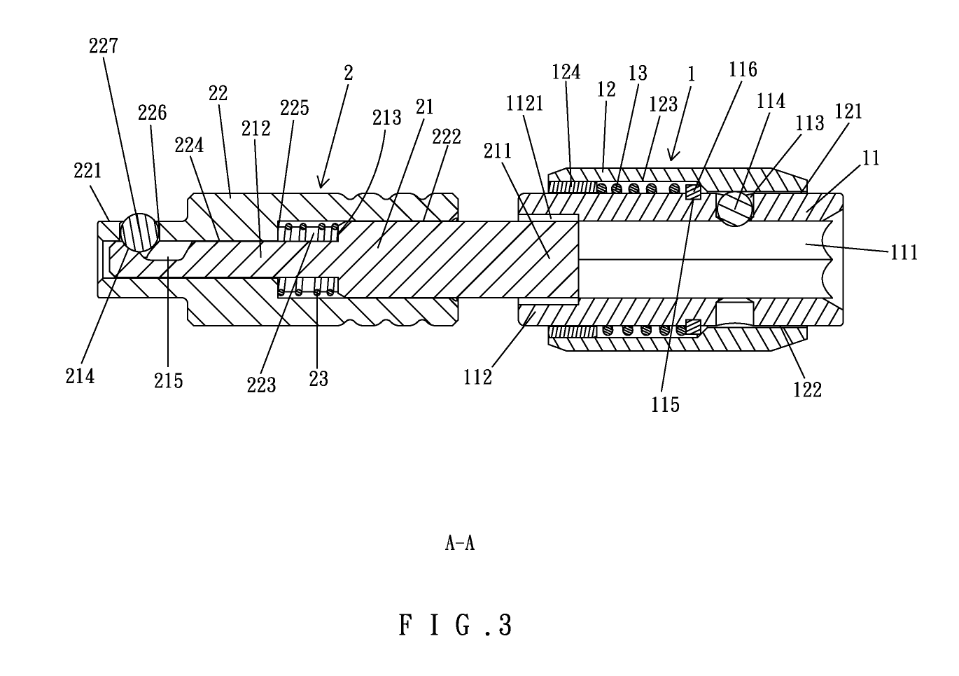

With reference to FIGS. 1-4, a tool adapter according to the present invention includes a driving member coupling mechanism 1 and a tool coupling mechanism 2. The driving member coupling mechanism 1 includes a first sleeve 11, a movable sleeve 2, and a first elastic element 13. The first sleeve 11 includes front and rear ends spaced in an axial direction. The rear end of the first sleeve 11 includes an insertion hole 111 for engaging with an end of a screwdriver shank 3 of an automatic tool 4. The front end of the first sleeve 11 includes a coupling section 112 for engaging with the tool coupling mechanism 2. The coupling section 112 includes a coupling hole 1121. The first sleeve 11 further includes a first through-hole 113 extending in a radial direction perpendicular to the axial direction and in communication with the insertion hole 111. A first ball 114 is received in the first through-hole 113. An inner end of the first through-hole 113 has a diameter smaller than a diameter of the first ball 114. The position of the first through-hole 113 corresponds to a coupling groove 31 of the screwdriver shank 3. Structure of the coupling groove 31 of the screwdriver shank 3 is conventional and therefore not described in detail to avoid redundancy. An annular groove 115 is defined in an outer periphery of the first sleeve 11 and receives a first stop ring 116.

The movable sleeve 12 includes a sleeve hole 121 in a center thereof for receiving the first sleeve 11. A first inner annular wall portion 122 is provided on a rear end of an inner periphery of the movable sleeve 12 and protrudes into the insertion hole 111. The first ball 114 is pressed against by the first inner annular wall 12 to partially protrude out of the insertion hole 111. The first inner annular wall portion 122 has a diameter smaller than an outer diameter of the first stop ring 116. A second inner annular wall portion 123 is provided on a front end of the inner periphery of the movable sleeve 12. The second inner annular wall portion 123 has a diameter larger than that of the first inner annular wall portion 122. The second inner annular wall portion 123 receives an edge of the first ball 114 such that the first ball 114 does not protrude out of the insertion hole 111. A second stop ring 124 is mounted in a front end of the second inner annular wall portion 123. The first elastic element 13 provides a returning function for the movable sleeve 12 and biases the movable sleeve 12 to a first position in which the first inner annular wall portion 122 is aligned with the first ball 114. When the movable sleeve 12 moves relative to the first sleeve 11 in the axial direction to a second position, the second inner annular wall portion 123 is aligned with the first ball 114. The first elastic element 13 is in the form of a compression spring and mounted around the first sleeve 11, with two ends of the first elastic element 13 abutting against the first and second stop rings 116 and 124, providing the movable sleeve 12 with operative resilience.

The tool coupling mechanism 2 includes a coupling rod 21, a second sleeve 22, and a second elastic element 23. The coupling rod 21 is coaxial to the first sleeve 11 and includes rear and front sections 211 and 212. The rear section 211 of the coupling rod 21 is securely engaged in the coupling hole 1121 of the coupling section 112 of the first sleeve 11. The front section 212 has a diameter smaller than that of the rear section 211, with a first shoulder 213 formed between the front and rear sections 212 and 211. The front section 212 includes a front end having a first abutment section 214 and a second abutment section 215, with the first abutment section 214 shallower than the abutment section 215 in the radial direction.

An engagement portion 221 is provided on a front end of the second sleeve 22 for coupling with a tool, such as a socket 5. The second sleeve 22 further includes an engagement groove 222 extending in the axial direction in a central portion thereof for receiving the coupling rod 21. The engagement groove 222 includes rear and front groove sections 223 and 224 in rear and front ends thereof and having sizes corresponding to the rear and front sections 211 and 212 of the coupling rod 21. A second shoulder 225 is formed between the rear and front groove sections 223 and 224. The second sleeve 22 further includes a second through-hole 226 extending in a radial direction perpendicular to the axial direction and in communication with the front groove section 224. The second through-hole 226 is in a location corresponding to the first and second abutment sections 214 and 215. A second ball 227 is received in the second through-hole 226. The second through-hole 226 includes an outer end having a diameter smaller than a diameter of the second ball 227. The second ball 227 can partially protrude out of the second through-hole 226 without disengaging from the second through-hole 226.

The second elastic element 13 provides a returning function for the second sleeve 22 relative to the coupling rod 21. The second elastic element 13 biases the coupling rod 21 such that the first abutment section 214 of the coupling rod 21 is normally aligned with the second ball 227, with the second ball 227 partially protruded out of the second through-hole 226. When the second sleeve 22 moves in the axial direction such that the second ball 227 is in the second abutment section 215 of the coupling rod 21, the second ball 227 does not extend beyond the second through-hole 226. The second elastic element 13 provides the second sleeve 22 with a returning force. The second elastic element 23 is in the form of a compression spring mounted in the rear groove section 223 of the second sleeve 22, with two ends of the second elastic element 23 abutting against the first and second shoulders 213 and 225 to provide the second sleeve 22 with operative resilience.

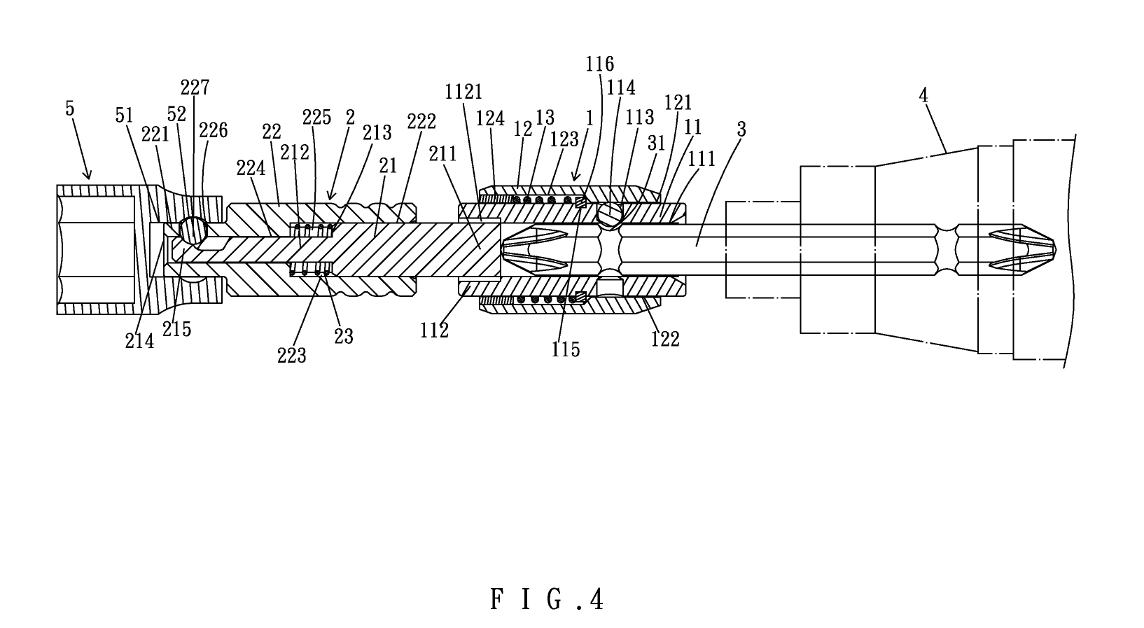

With reference to FIG. 4, the driving member coupling mechanism 1 is coupled with the screwdriver shaft 3 of the automatic tool 4. The tool coupling mechanism 2 is coupled with the socket 5. The movable sleeve 12 can be operated to allow the screwdriver shank 3 to be inserted into the insertion hole 111. When the movable sleeve 12 is released, the first ball 114 engages with the coupling groove 31 of the screwdriver shank 3, preventing the tool adapter from disengaging from the screwdriver shank 3. The socket 5 is coupled with the engagement portion 221 of the second sleeve 2 of the tool coupling mechanism 2, with a receptacle 51 of the socket 5 receives the engagement portion 221, with the second ball 227 engaged with a recess 52 of the socket 5, preventing the socket 5 from disengaging from the tool adapter. The receptacle 51 and the recess 52 of the socket 5 are conventional and therefore not described in detail to avoid redundancy. When the automatic tool 4 operates, the tool adapter and the socket 5 are driven to rotate via transmission by the screwdriver shank 3.

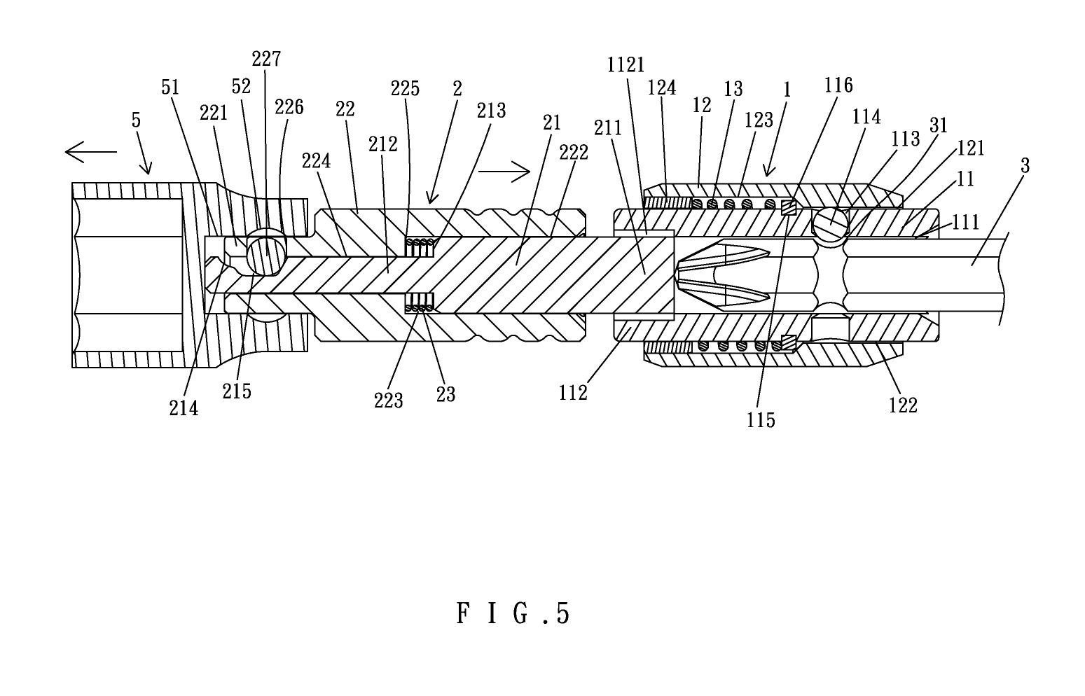

With reference to FIG. 5, when it is desired to replace the socket 5 with another socket 5 having a different size, the second sleeve 22 of the tool coupling mechanism 2 is moved in the axial direction and compresses the second elastic element 23. The second ball 227 is located at the second abutment section 215 of the coupling rod 21 and disengaged from the recess 52 of the socket 5, allowing easy removal of the socket 5 for rapid replacement of another socket 5. After replacement, the second sleeve 22 is returned to its initial position by the second elastic element 23, with the first abutment section 214 pressing against the second ball 227 to a position partially protruding out of the second through-hole 226.

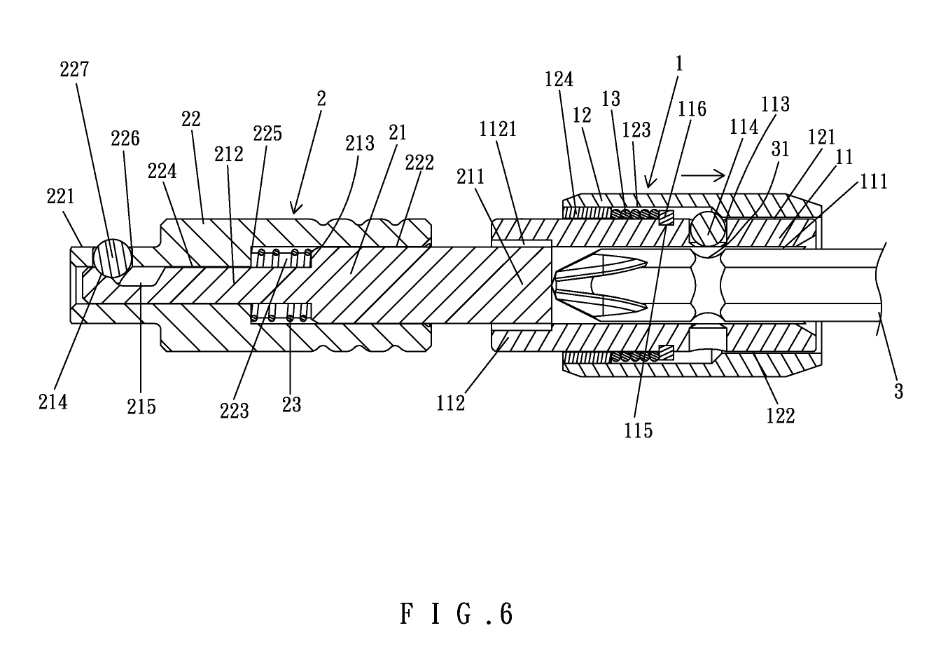

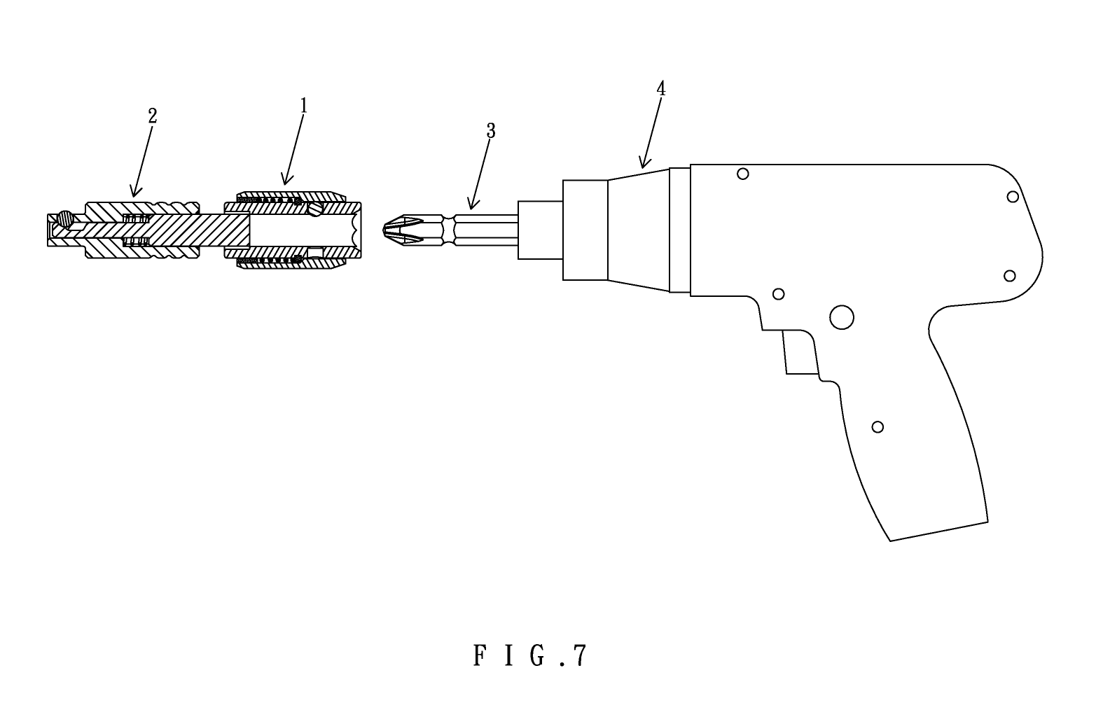

With reference to FIGS. 6 and 7, a user can simply actuate the movable sleeve 12 to move in the axial direction and to compress the first elastic element 13 by the screwdriver shank 3 of the automatic tool 4, such that the first ball 114 is disengaged from the coupling groove 31 of the screwdriver shank 3. Thus, the tool adapter can be easily detached from the screwdriver shank 3, allowing the user to use the screwdriver shank 3.

In view of the foregoing, the tool adapter according to the present invention can be easily and rapidly coupled with and detached from the socket 5 and the screwdriver shank 3 of the automatic tool 4, providing operational convenience and providing enhanced stability after assembly.

Although specific embodiments have been illustrated and described, numerous modifications and variations are still possible without departing from the essence of the invention. The scope of the invention is limited by the accompanying claims.

1. A tool adapter comprising:
a driving member coupling mechanism including a first sleeve, a movable sleeve, and a first elastic element, with the first sleeve including front and rear ends spaced in an axial direction, with the rear end of the first sleeve including an insertion hole, with the insertion hole adapted to couple with a screwdriver shank of an automatic tool, with the first sleeve further including a first through-hole extending in a radial direction perpendicular to the axial direction and in communication with the insertion hole, with a first ball received in the first through-hole, with the movable sleeve including a sleeve hole receiving the first sleeve, with the movable sleeve movable in the axial direction relative to the first sleeve, causing the first ball to move between a first location partially protruding out of the insertion hole and a second location not protruding out of the insertion hole, with the first elastic element biasing the movable sleeve to a first position in which the first ball protrudes out of the insertion hole, with the movable sleeve movable to a second position in which the first ball does not protrude out of the insertion hole; and
a tool coupling mechanism including a coupling rod, a second sleeve, and a second elastic element, with the coupling rod coaxial to the first sleeve and including rear and front sections, with the rear section of the coupling rod securely engaged with the front end of the first sleeve, with the front section of the coupling rod including a front end having a first abutment section and a second abutment section, with the second sleeve including a front end having an engagement portion, with the engagement portion of the second sleeve adapted to couple with a tool, with the second sleeve further including an engagement groove extending in the axial direction, with the engagement groove receiving the coupling rod, with the engagement groove including rear and front groove sections in rear and front ends thereof and having sizes corresponding to the rear and front sections of the coupling rod, with the second sleeve further including a second through-hole extending in a radial direction perpendicular to the axial direction and in communication with the front groove section, with the second through-hole located corresponding to the first and second abutment sections of the coupling rod, with a second ball received in the second through-hole, with the second elastic element providing a returning function for the second sleeve relative to the coupling rod, with the second elastic element biasing the coupling rod such that the second ball partially protrudes out of the second through-hole, with the second sleeve movable in the axial direction to a position in which the second ball does not protrude out of the second through-hole.

2. The tool adapter as claimed in claim 1, with the driving member coupling mechanism further including first and second stop rings, with the front end of the first sleeve including a coupling section having a coupling hole, with the first sleeve including an annular groove in an outer periphery thereof, with the first stop ring received in the annular groove, with a first inner annular wall portion provided on a rear end of an inner periphery of the movable sleeve and protruding into the insertion hole, with the first inner annular wall portion having a diameter smaller than an outer diameter of the first stop ring, with a second inner annular wall portion provided on a front end of the inner periphery of the movable sleeve and having a diameter larger than the diameter of the first inner annular wall portion, with the second inner annular wall portion receiving an edge of the first ball such that the first ball does not protrude beyond the insertion hole, with the second stop ring located in a front end of the second inner annular wall portion, with the first elastic element being a compression spring mounted around the first sleeve, with the first elastic element including two ends abutting against the first and second stop rings, providing the movable sleeve with operative resilience.

3. The tool adapter as claimed in claim 2, with the first through-hole including an inner end having a diameter smaller than a diameter of the first ball.

4. The tool adapter as claimed in claim 2, with the rear section of the coupling rod securely engaged with the coupling hole of the coupling section of the first sleeve, with the front section of the coupling rod having a diameter smaller than a diameter of the rear section of the coupling rod, with a first shoulder formed between the front and rear sections of the coupling rod, with the first abutment section shallower than the second abutment section, with the second elastic element being a compression spring mounted in the rear groove section of the second sleeve, with the second sleeve including a second shoulder between the rear and front groove sections, with the second elastic element including two ends abutting against the first and second shoulders, providing the second sleeve with operative resilience.

5. The tool adapter as claimed in claim 4, with the second through-hole including an outer end having a diameter smaller than a diameter of the second ball.
